(19) United States
(12) Patent Application Publication
(10) Pub. No.: US 2021/0197165 A1
(43) Pub. Date: Jul. 1, 2021

(54) STRUCTURE HAVING FLOW CHANNEL AND METHOD FOR MANUFACTURING THE SAME

(71) Applicant: CANON KABUSHIKI KAISHA, Tokyo (JP)

(72) Inventors: Hiroshi Saito, Kanagawa (JP); Nobuhiro Yasui, Kanagawa (JP); Kanako Oshima, Tokyo (JP); Makoto Kubota, Kanagawa (JP)

(21) Appl. No.: 17/183,101

(22) Filed: Feb. 23, 2021

Related U.S. Application Data
(63) Continuation of application No. PCT/JP2019/029924, filed on Jul. 31, 2019.

(30) Foreign Application Priority Data
Aug. 24, 2018 (JP) 2018-157803
Jul. 24, 2019 (JP) 2019-136398

(51) Int. Cl. B01J 19/00; C04B 35/103; C04B 41/45; C04B 35/626

(52) U.S. Cl. CPC B01J 19/0093; C04B 35/103; C04B 41/4586; C04B 41/4554; C04B 41/4535; C04B 41/4545; B01J 2219/00824; C04B 2235/3217; C04B 2235/3224; C04B 2235/665; C04B 2235/3244; B01J 2219/00804; B01J 2219/00813; C04B 35/6269

(57) ABSTRACT

A structure having excellent rectification performance and durability and having a micro flow channel is provided. The structure has a flow channel in the inside, wherein the cross section of the flow channel has a shape in which a region surrounded by a substantially elliptical curve and a line segment is connected to a triangular region with the base being the line segment, the region surrounded by the line segment and the substantially elliptical curve is semielliptical or more, and the base angle of the triangular region is 45 degrees or more.

### CROSS-REFERENCE TO RELATED APPLICATIONS

This application is a Continuation of International Patent Application No. PCT/JP2019/029924, filed Jul. 31, 2019, which claims the benefit of Japanese Patent Application No. 2018-157803, filed Aug. 24, 2018 and No. 2019-136398, filed Jul. 24, 2019, both of which are hereby incorporated by reference herein in their entirety.

### TECHNICAL FIELD

The present invention relates to a structure having a flow channel and a method for manufacturing the same.

### BACKGROUND ART

A micro flow channel is used for the purpose of subjecting a substance in a fluid to reaction, separation, refining, heat exchange, or detection. To efficiently achieve the above-described various purposes and to stably obtaining a homogeneous target material, rectification performance in a flow channel has to be enhanced.

PTL 1 discloses a device provided with a micro flow channel having a semicircular cross section. From the viewpoint of the rectification performance of the liquid that passes through a flow channel, it is preferable that the cross section of the micro flow channel be made into the shape of a circle, an ellipse, or the like that has a symmetrical curve.

Since the micro flow channel has a complex structure such as a turn and a branch in many cases, the micro flow channel produced for an industrial purpose is produced by bonding a plurality of base materials together in general. Specifically, one base material of the plurality of base materials is provided with a groove, and a flat surface of another base material is bonded so as to put the lid on the groove. As a result, the flow channel can be produced at a low cost. Consequently, the flow channel has a semicircular cross section, as described in PTL 1, in many cases.

### CITATION LIST

### Patent Literature

PTL 1 Japanese Patent Laid-Open No. 2017-116090

In the case in which a semicircular flow channel is produced by bonding base materials, the connection portion of a curved surface and a flat surface is in accord with the bonded surface of the base material while the flow channel is narrowed and, therefore, is a place on which the stress due to a fluid tends to concentrate. Consequently, cracking may occur in the connection portion of the curved surface and the flat surface due to deterioration, and the fluid may leak.

The present invention was realized to address such problems, and it is an object to provide a structure having a micro flow channel that is excellent in rectification performance and durability by performing integral production rather than bonding a plurality of base materials.

### SUMMARY OF INVENTION

A structure to address the above-described problems has a flow channel in the inside, wherein the cross section of the flow channel has a shape in which a region surrounded by a substantially elliptical curve and a line segment is connected to a triangular region with the base being the line segment, the region surrounded by a substantially elliptical curve and a line segment is semielliptical or more, and the base angle of the triangular region is 45 degrees or more.

Further features of the present invention will become apparent from the following description of exemplary embodiments with reference to the attached drawings.

### BRIEF DESCRIPTION OF DRAWINGS

FIG. 1A is an overall view illustrating a structure according to the present invention.

FIG. 1B is a diagram illustrating the cross section cut along line IB-IB in FIG. 1A.

FIG. 2A is a diagram illustrating an example of a favorable cross-sectional shape of a flow channel included in a structure according to the present invention.

FIG. 2B is a diagram illustrating an example of a favorable cross-sectional shape of a flow channel included in a structure according to the present invention.

FIG. 3A is a sectional view of a structure having a plurality of flow channels according to the present invention.

FIG. 3B is a sectional view of a structure having a plurality of flow channels in a comparative example.

FIG. 4A is a schematic sectional view illustrating a method for manufacturing a structure by using a powder bed system and is a diagram illustrating a state in which a powder is placed on a base.

FIG. 4B is a schematic sectional view illustrating a method for manufacturing a structure by using a powder bed system and is a diagram illustrating a state in which a powder layer is formed.

FIG. 4C is a schematic sectional view illustrating a method for manufacturing a structure by using a powder bed system and is a diagram illustrating a state in which a solidified portion is formed in the region of the powder layer irradiated with an energy ray.

FIG. 4D is a schematic sectional view illustrating a method for manufacturing a structure by using a powder bed system and is a diagram illustrating a state in which a new powder layer is formed on the solidified portion.

FIG. 4E is a schematic sectional view illustrating a method for manufacturing a structure by using a powder bed system and is a diagram illustrating a state in which a solidified portion is formed in the region of the newly formed powder layer irradiated with an energy ray.

FIG. 4F is a schematic sectional view illustrating a method for manufacturing a structure by using a powder bed system and is a diagram illustrating a state in which a shaped material having a predetermined shape is formed.

FIG. 4G is a schematic sectional view illustrating a method for manufacturing a structure by using a powder bed system and is a diagram illustrating a state in which a powder in an unsolidified portion is removed.

FIG. 4H is a schematic sectional view illustrating a method for manufacturing a structure by using a powder bed system and is a diagram illustrating a shaped material separated from the base.

FIG. 5A is a schematic sectional view illustrating a method for manufacturing a structure by using a cladding method and is a diagram illustrating a state in which a solidified portion is formed by applying an energy ray to a region on which a powder is focused.

FIG. 5B is a schematic sectional view illustrating a method for manufacturing a structure by using a cladding method and is a diagram illustrating a state in which a solidified portion is further formed on the solidified portion.

FIG. 5C is a schematic sectional view illustrating a method for manufacturing a structure by using a cladding method and is a diagram illustrating a state in which a predetermined shaped portion is formed.

FIG. 6 is a sectional view illustrating a favorable method for shaping a structure according to the present invention by using a powder bed system.

FIG. 7A is a diagram illustrating the process for shaping a portion having no flow channel of a structure by laser irradiation in Examples 1 to 34.

FIG. 7B is a diagram illustrating the process for shaping a portion having no flow channel of a structure by laser irradiation in Examples 1 to 34.

FIG. 8A is a diagram illustrating the process for shaping a flow channel by laser irradiation in Examples 1 to 34 and is a diagram illustrating a state in which the vicinity of the bottom portion of a substantially elliptical portion of a flow channel is formed.

FIG. 8B is a diagram illustrating the process for shaping a flow channel by laser irradiation in Examples 1 to 34 and is a diagram illustrating a state in which a portion at some height of an elliptical portion of a flow channel is formed.

FIG. 8C is a diagram illustrating the process for shaping a flow channel by laser irradiation in Examples 1 to 34 and is a diagram illustrating a state in which a triangular portion of a flow channel is formed.

FIG. 8D is a diagram illustrating the process for shaping a flow channel by laser irradiation in Examples 1 to 34 and is a diagram illustrating a state in which a portion at some height of a triangular portion of a flow channel is formed.

FIG. 8E is a diagram illustrating the process for shaping a flow channel by laser irradiation in Examples 1 to 34 and is a diagram illustrating a state in which a portion having no flow channel is formed.

FIG. 9A is a diagram illustrating a structure which is produced in Example 35 and which has a plurality of micro flow channels.

FIG. 9B is a diagram illustrating a structure which is produced in Example 35 and which has a plurality of micro flow channels.

FIG. 10 is a diagram illustrating a structure which is produced as a comparative example of Example 35 and which has a plurality of micro flow channels.

FIG. 11A is an overall view of a structure which is produced in Examples 36 to 39 and which has a T-shaped micro flow channel.

FIG. 11B is a top view of a flow channel formed in the structure in FIG. 11A.

### DESCRIPTION OF EMBODIMENTS

The embodiments according to the present invention will be described below.

Structure

The structure according to the present invention is a structure having a flow channel in the inside. Such a structure can be used for various applications such as chemical reaction and heat exchange. The flow channel may include a turn and a branch and may be single or plural. In the present invention, “single flow channel” denotes a flow channel independent of another flow channel in the structure. For example, even a flow channel which is branched on the way is a single flow channel provided that the branches are in communication with each other.

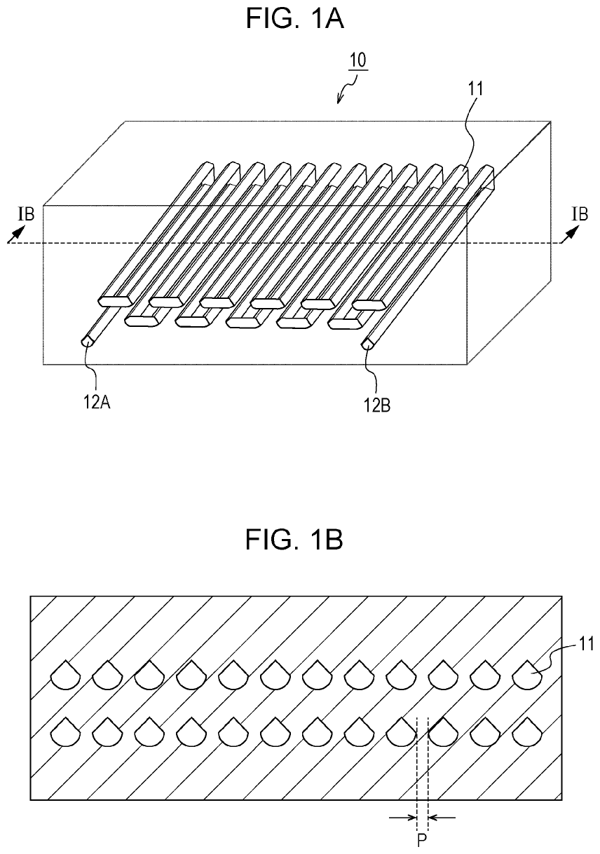

FIGS. 1A and 1B illustrate an example of a structure having a micro flow channel. FIG. 1A is an overall view of a structure 10. In FIG. 1A, for the sake of facilitating explanations, a micro flow channel 11 inside the structure 10 is visualized. FIG. 1B is a diagram illustrating the cross section cut along line IB-IB in FIG. 1A.

As shown in FIG. 1A, the micro flow channel 11 (also simply referred to as a flow channel) 11 has a structure in communication with the outside of the structure 10. As the situation demands, the flow channel may be branched on the way. Preferably, the surface of the structure 10 be provided with at least one feed port 12A for feeding a fluid that passes through the micro flow channel 11 from the outside and at least one discharge port 12B for discharging the fluid to the outside.

In accordance with an increase in the flow channel length L of the micro flow channel 11, the retention time of the fluid in the flow channel increases, and the time for performing reaction or heat exchange can be sufficiently ensured. In the case in which a large flow channel length L is necessary, as illustrated in FIG. 1A, it is preferable that the flow channel 11 meander and turn inside the structure. In this regard, the flow channel length L denotes the total length of the flow channel from the feed port 12A to the discharge port 12B. In the case in which the flow channel 11 branches or merges on the way, the flow channel length L denotes the largest flow channel length from the feed port 12A to the discharge port 12B of the flow channels in communication with each other.

The micro flow channel 11 being highly densely arranged enables the efficiency of reaction, heat exchange, or the like to be enhanced. Consequently, it is desirable that the micro flow channel 11 inside the structure be disposed so as to become parallel to each other except turn portions, as illustrated in FIG. 1A. The distance P between the flow channels disposed parallel to each other is preferably 10 mm or less and more preferably 5 mm or less. In this regard, the distance P being 0.3 mm or more is preferable because sufficient strength of the structure is obtained.

The material for forming the structure 10 can be appropriately selected from ceramic, metals, resins, and the like in accordance with the application. Of these, ceramic materials are preferable since the structure composed of the ceramic material has excellent chemical resistance and heat resistance compared with other materials such as metals and resins and, therefore, can realize a micro flow channel usable under various conditions.

The ceramic denotes solid inorganic compounds (except metals). Meanwhile, the inorganic compounds in the present invention include oxides, nitrides, oxynitrides, carbides, and borides that contain at least one element selected from a group consisting of elements of group I except hydrogen to group XIV of the periodic table, antimony, and bismuth.

Of the ceramic materials, aluminum oxide (alumina), zirconium oxide (zirconia), and silicon carbide are particularly preferable because of low solubility into strong acids and strong alkalis and excellent corrosion resistance, and, in addition, because of excellent hermeticity due to densification. Therefore, it is preferable that the structure contain at least one component selected from aluminum oxide, zirconium oxide, and silicon carbide as a primary component. In this regard, the primary component denotes a component having a proportion of 50% by mole or more in the material composition constituting the structure 10.

In the case in which the structure 10 according to the present invention is composed of ceramic, the entirety is not limited to being crystalline and may be partly composed of an amorphous material and the like. To improve the corrosion resistance of the structure 10, it is preferable that a wetted portion is crystalline.

Cross-Sectional Shape of Flow Channel

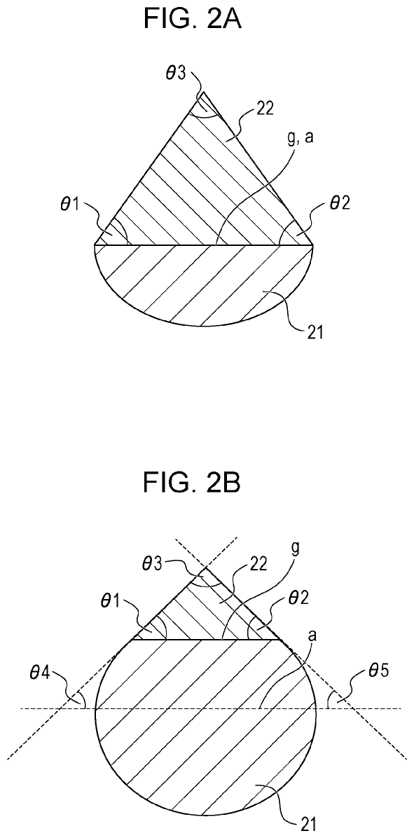

FIGS. 2A and 2B illustrate favorable examples of the cross section of the flow channel included in the structure 10 according to the present invention in the direction which intersects the extension direction of the flow channel and in which the area of the flow channel is minimum. Diagonally hatched regions in FIGS. 2A and 2B illustrate the cross-sectional shapes of the flow channels. In FIG. 2A or FIG. 2B, the line surrounding the hatched region corresponds to the wall surface of the structure 10 facing the flow channel. The flow channel has a shape in which a region 21 surrounded by a substantially elliptical curve and a line segment g (hereafter referred to as an elliptical portion) is connected to a triangular region 22 with the base being the line segment g (hereafter referred to as a triangular portion).

In this regard, the elliptical portion 21 is semielliptical or more. When the major diameter of the elliptical portion 21 is denoted as a, it can also be said that the cross-sectional shape of the flow channel includes a semielliptical shape having a major diameter of a. It can also be said that the cross section of the flow channel is the shape of a hole which appears when the micro flow channel is cut in the direction perpendicular to the flow direction of the fluid.

The semiellipse denotes a shape of a half ellipse obtained by dividing an ellipse along the major axis. In the present invention, in the case in which a curve is approximated to part of an ellipse and the relative error that is obtained by dividing the distance between the curve and the approximate ellipse (error r) by the major diameter a of the elliptical curve is 20% or less, the curve is denoted as a substantially elliptical curve. The substantial ellipse is an express including an ellipse. In this regard, an ellipse includes a circle.

An elliptical approximate curve of the curved portion can be determined by, for example, observing the cross section of the micro flow channel with an optical microscope, subjecting the curved portion to image processing so as to extract the edge, and fitting an ellipse by using a least square method. From the viewpoint of ensuring rectification performance, the relative error obtained by dividing the error r between the edge-extracted curved portion and the approximate curve by the major diameter a is preferably 15% or less and more desirably 10% or less.

A semiellipse has a cross-sectional shape in which the pressure of the fluid is not readily concentrated on part of the inner wall. Consequently, the cross section of the flow channel including a semielliptical shape enables breakage due to stress concentration to be reduced. In the present specification, the semielliptical approximate curve is also simply expressed as a semiellipse.

More preferably, the cross section of the flow channel 11 includes a semicircular shape. Since the quantity of flow can be increased at an equal flow speed, a semicircular shape is more preferable than the case in which a semielliptical shape having a major diameter that is the same length as the diameter of the semicircle is included.

The cross-sectional area S of the flow channel included in the structure according to the present invention satisfies the relationship represented by πa²/8<S≤(3π+6)a²/16 where a denotes the major diameter of the substantially elliptical curve. Hereafter the major diameter a is also referred to as the major diameter of the elliptical portion 21.

The cross-sectional area S of the flow channel being larger than πa²/8 enables the cross section of the flow channel to pass through a larger quantity of fluid at an equal flow speed than the flow channel including the semicircular shape having a diameter of a. From the viewpoint of increasing the quantity of flow, it is more preferable that S be larger than 1.5×πa²/8.

In the case in which the cross-sectional area S of the flow channel is (3π+6)a²/16 or less, sufficient rectification performance is obtained. The diameter of a circle having the same area as the cross-sectional area S is denoted as an equivalent diameter c. If a difference between the major diameter a of the elliptical portion and the equivalent diameter c increases, a turbulent flow tends to be caused. In the case in which S is (3π+6)a²/16 or less, a difference between the equivalent diameter c and the major diameter a of the elliptical portion decreases, and favorable rectification performance can be obtained. More preferably, S is 0.97×(3π+6)a²/16 or less.

The major diameter a of the semiellipse is preferably 0.5 mm or more and 3.5 mm or less and more preferably 0.8 mm or more and 3.2 mm or less. If the major diameter a decreases, the influence of the temperature or the quantity of flow of the fluid on various purposes, for example, reaction, separation, refining, heat exchange, and detection, tends to increase, there is a concern that the result material obtained by passing the fluid through the flow channel 11 may become heterogeneous. The major diameter a is preferably 0.5 mm or more because a homogeneous result material is obtained and is more preferably 0.8 mm or more. Meanwhile, if the major diameter a increases, a turbulent flow tends to occur in the fluid passing through the flow channel 11. In the case in which a is 3.5 mm or less, rectification performance sufficient for stably obtaining a homogeneous result material can be obtained. More preferably, a is 3.2 mm or less.

The eccentricity e of the ellipse is represented by the following formula where the major diameter is denoted as a and the minor axis is denoted as b.

$$e = \sqrt{1 - \frac{{b}^{2}}{{a}^{2}}} \qquad [ Math . 1 ]$$

The eccentricity e of the ellipse is denoted as e where the curve included in the cross section of the flow channel is approximated to the ellipse. In the present specification, e is also referred to as the eccentricity of a semiellipse. At this time, the eccentricity e of the semiellipse is preferably 0 or more and 0.95 or less. In the case in which the semiellipse is a semicircle, e is zero. If e increases, the ellipse becomes flat and the flow of the fluid tends to be disturbed. Preferably, e is 0.95 or less, and more preferably, e is 0.90 or less. If gas remains in the flow channel through which the liquid passes, deterioration in rectification performance is caused due to movement of the gas, and there is a concern that a chemical reaction in the micro flow channel may become nonuniform. To enhance the rectification performance of the liquid passing through the flow channel, it is desirable that gas in the flow channel be discharged outside the flow channel as much as possible until the quantity of the liquid passing through the flow channel becomes constant. However, it is difficult to completely remove the gas in the flow channel in practice.

Regarding the flow channel according to the present invention, gas in the flow channel can be efficiently discharged, and, in addition, even when gas remains in the flow channel, an influence of the remaining gas on the reaction and the rectification performance can be reduced by devising the shape of the triangular portion included in the cross section of the flow channel. Specifically, it is desirable that the ratio R of the area Y of the triangular region with the base being a line segment to the area X of the region surrounded by the substantially elliptical curve and the line segment be set to be more than 0 and 3 or less.

$$R = \frac{Y}{X} \qquad [ Math . 2 ]$$

Preferably, R is 3 or less because most of gas is discharged outside the flow channel until the quantity of the liquid passing through the flow channel becomes constant. More preferably, R is 2 or less, and 0.7 or less is further preferable.

In the case in which there is gas remaining in the flow channel at the time when the quantity of the liquid passing through the flow channel becomes constant, it is preferable that the cross section of the flow channel have a triangular region, that is, R>0 be satisfied, because gas is readily held in the apex portion of the triangular shape. As a result, excellent rectification performance and a stable chemical reaction can be realized.

As described above, in accordance with an increase in the flow channel length L of the micro flow channel, the retention time of the liquid in the flow channel increases, and chemical reaction or heat exchange is sufficiently performed. Therefore, a larger flow channel length L is preferable. The flow channel length L is preferably 10 times or more the major diameter a of the elliptical portion 21 constituting the cross section of the flow channel and more preferably 20 times or more.

In the case in which the flow channel has a cross-sectional shape as illustrated in FIG. 2A or FIG. 2B, since the cross-sectional area is larger than a semicircle having a diameter equal to the major diameter a of the elliptical portion 21, a larger quantity of fluid per unit time can flow. In addition, as described later in detail, the cross-sectional shape having a triangular portion enables heat transfer between adjacent flow channels to become more uniform in the case in which a plurality of flow channels are arranged. Consequently, for example, in the case in which heat exchange is performed between flow channels, more uniform and efficient heat exchange can be realized compared with the flow channel having a semicircular cross-sectional shape in the related art.

One side of the triangular portion may be the major axis of a semiellipse as illustrated in FIG. 2A or may be a line segment parallel to the major axis of a substantial ellipse as illustrated in FIG. 2B.

In accordance with the purpose of use, part of or the entire wetted portion of the flow channel, that is, the wall surface in contact with the fluid passing through the flow channel (wall surface of the flow channel), may has a porous structure. For example, in the case in which a wetted portion of the flow channel is allowed to carry a catalyst, having the porous structure is preferable. The wetted portion of the flow channel having the porous structure enables the specific surface area to be increased, and the porous portion carrying the catalyst enable the reaction to be facilitated. There is no particular limitation regarding the arrangement of the porous structure in the flow channel. For example, the wall surface of the elliptical portion 21 in the wetted portion of the flow channel may have the porous structure.

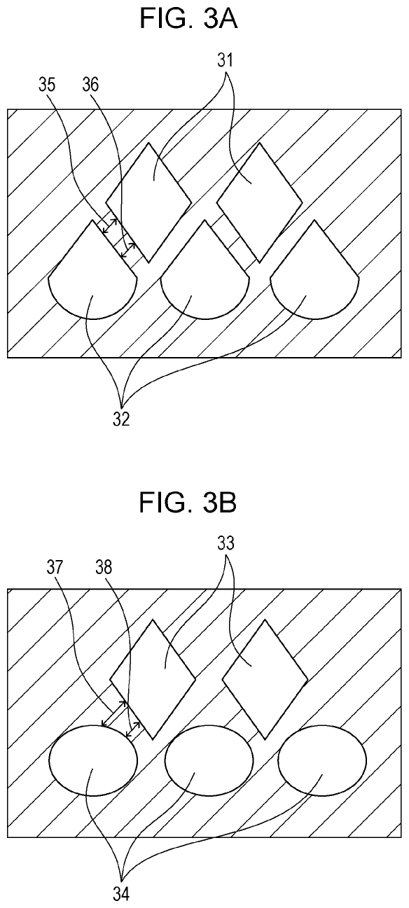

In a more preferable aspect, a plurality of flow channels are included inside the structure according to the present invention, as illustrated in FIGS. 3A and 3B. Each of the plurality of flow channels may be merged or branched on the way. The type of the fluid that passes through each of the plurality of flow channels may differ from each other. In the case in which the structure has a plurality of flow channels, it is preferable that at least one flow channel of the flow channels through which the target fluid of reaction, separation, refining, heat exchange, detection, or the like passes have a cross-sectional shape composed of a combination of a semiellipse and a triangle having a side bordering the semiellipse, as illustrated in FIGS. 2A and 2B. In the case in which a plurality of flow channels are arranged, part of the cross section including a triangular shape enables the distances between the flow channels to be constant. The distances between the flow channels being constant enables heat transfer between the liquids passing through the respective flow channels to be more uniform.

For example, a structure which has a flow channel for passing high-temperature water and a flow channel for passing a reaction solution and in which a reaction is facilitated by transferring heat of the high-temperature water to the reaction solution is considered. The structure according to the present invention illustrated in FIG. 3A has a flow channel 31 that is a flow channel for passing high-temperature water and that has a cross-sectional shape of a parallelogram and a flow channel 32 that is a flow channel for passing a reaction solution and that has a cross-sectional shape composed of a combination of a substantial semiellipse and a triangle. Meanwhile, a structure illustrated in FIG. 3B has a flow channel 33 similar to the flow channel 31 in FIG. 3A and a flow channel 34 that is a flow channel for passing a reaction solution and that has an elliptical cross-sectional shape.

In the case of FIG. 3A, a portion in which the distances 35 and 36 between the flow channel 31 and the flow channel 32 are constant can be disposed by arranging one wall surface of the flow channel 31 in parallel to the wall surface of the triangular portion of the flow channel 32. Therefore, the distance between the fluid passing through the flow channel 31 and the fluid passing through the flow channel 32 can be maintained constant, and heat transfer from the high-temperature water to the reaction solution can be made uniform. On the other hand, in the case of FIG. 3B, since the flow channel 34 has just a curved portion, the distances 37 and 38 from the flow channel 33 differ in accordance with the positions, and the heat transfer does not become uniform.

Method for Manufacturing Structure

There is no particular limitation regarding the method for manufacturing the structure according to the present invention, and it is preferable that an additive manufacturing technology, in other words, a three-dimensional shaping method that is a direct shaping system be applied. Most of all, a powder bed direct shaping system (hereafter referred to as a powder bed system) and a directed energy additive manufacturing system (cladding system) so as to build-up a material are suitable. The structure according to the present invention having a micro flow channel can be integrally produced by applying these systems.

The powder bed system will be described below with reference to ceramic shaping as an example. The method for manufacturing the structure by using the powder bed system includes the following steps.

(i) Forming a powder layer
(ii) Selectively hardening a predetermined region of the powder layer in accordance with slice data

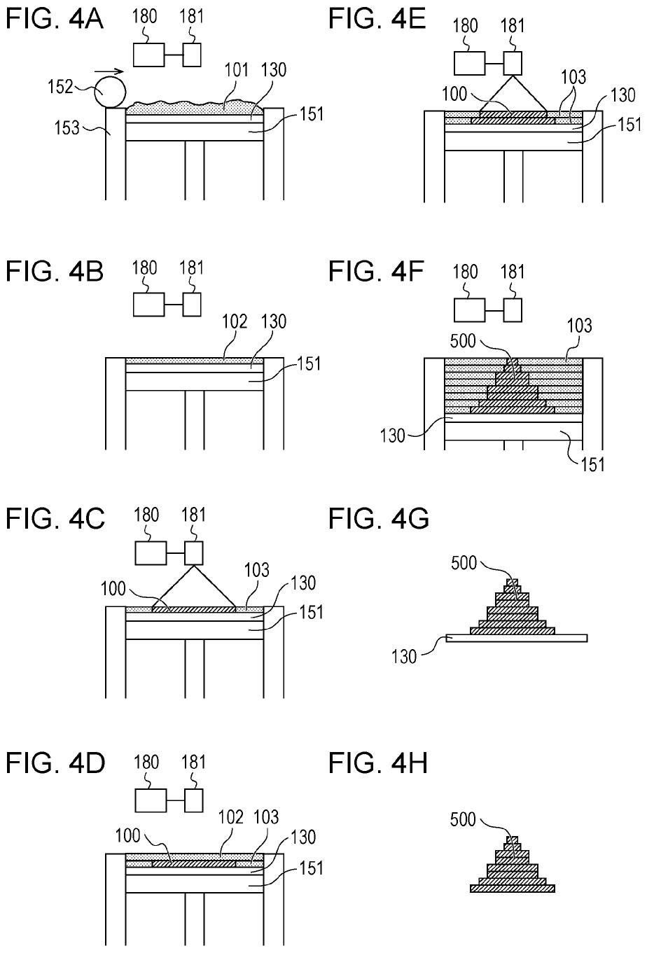

To begin with, a basic flow of shaping of the powder bed system will be described with reference to a specific example illustrated in FIGS. 4A to 4H. Initially, a powder 101 is placed on a base 130, and a powder layer 102 is formed by using a roller 152 (FIG. 4A, FIG. 4B). The surface of the powder layer 102 is irradiated with an energy ray emitted from an energy ray source 180 and scanned by a scanner portion 181 in accordance with slice data formed from three-dimensional data of the structure. As a result, particles contained in the powder in the region irradiated with an energy ray are melted and thereafter solidified so as to form a solidified portion (hardened portion) 100 in which particles are sintered with each other (FIG. 4C). A region not irradiated with an energy ray remains as an unsolidified (unhardened portion) 103 in which the powder is left as is. Subsequently, a stage 151 is lowered, and a powder layer 102 is newly formed on the solidified portion (hardened portion) 100 (FIG. 4D). The newly formed powder layer 102 is irradiated with an energy ray in accordance with the slice data so as to form a new solidified portion 100 and an unsolidified portion 103 (FIG. 4E).

A series of these steps is repeated so as to form a shaped material 500 having a predetermined shape (FIG. 4F). Finally, a powder of the unsolidified portion 103 is removed, and, as the situation demands, an unnecessary portion of the shaped material is removed and the shaped material is separated from the base 130 (FIG. 4G, FIG. 4H).

Next, a material powder used for ceramic shaping will be described, and thereafter each step will be described in detail.

Material Powder

A powder containing an inorganic compound as a primary component (hereafter referred to as an inorganic compound powder) is used as the material powder used for ceramic shaping. In the present invention, the inorganic compounds include oxides, nitrides, oxynitrides, carbides, and borides that contain at least one element selected from a group consisting of elements of group I except hydrogen to group XIV of the periodic table, antimony, and bismuth. The inorganic compound powder composed of a powder of the inorganic compound may be formed of one type of inorganic compound or may be a mixture of at least two types of inorganic compounds. In step (ii) described later, the inorganic compound powder being irradiated with an energy ray, melted, and solidified enables the result material to become ceramic-like.

The inorganic compound powder is a powder that can form a ceramic-like ceramic structure through steps (i) and (ii) according to the present invention and may be an amorphous powder. Meanwhile, to adjust the fluidity of the inorganic compound powder or the performance of a final ceramic structure, the inorganic compound powder may contain a small amount (10 parts by weight or less relative to 100 parts by weight of the inorganic compound powder) of resins, metals, and the like.

Particularly preferably, the inorganic compound in the inorganic compound powder contains a metal oxide as a primary component. The oxide contains a smaller amount of volatile components compared with other inorganic compounds and can realize stable melting in step (ii). In addition, the inorganic compound powder containing the metal oxide as a primary component enables a high-strength structure to be obtained. In this regard, the metal oxide denotes an oxide containing at least one element in an element group that is the above-described element group from which boron, carbon, silicon, germanium, and elements of group XIII (nitrogen group) and group XIV (oxygen group) are excluded. Regarding the inorganic compound powder and the metal oxide, it is preferable that aluminum oxide or zirconium oxide be the primary component. Aluminum oxide or zirconium oxide being a primary component of the shaped material and serving as an aggregate enables the structure having excellent corrosion resistance to strong acid or strong alkali, hermeticity, mechanical strength, and environmental suitability to be produced.

The inorganic compound powder may be composed of a simple metal oxide or may be used in combination with other substances so as to realize a new function and to become further desirable. Examples include a powder containing aluminum oxide and zirconium oxide and a powder containing aluminum oxide and a rare earth metal oxide such as gadolinium oxide or yttrium oxide. Regarding shaping by using such a powder, since eutectic crystals are formed during heating, a melting temperature is lowered compared with a simple metal oxide, and a melting-solidification reaction due to laser irradiation is relatively facilitated. In addition, since a eutectic structure appears in the structure during solidification after melting and cracks are suppressed from developing compared with a simple metal oxide, the mechanical strength and the hermeticity may be enhanced. From such a viewpoint, it is particularly preferable that the inorganic compound powder contain aluminum oxide and gadolinium oxide.

In the case in which a plurality of substances are combined, powders composed of the respective simple substances may be mixed so as to form a powder mixture or each particle contained in the powder may be composed of a solid solution of a plurality of substances.

Meanwhile, in the case in which the energy ray in step (ii) is a laser beam, since the inorganic compound powder sufficiently absorbs energy, spread of heat in the powder is suppressed and is localized, and thermal strain and a heat-affected zone are reduced so as to improve shaping accuracy. For example, in the case in which a Nd:YAG laser is used, Tb₄O₇, Pr₆O₁₁, or the like may be contained in the inorganic compound powder because of favorable absorption.

From the above-described viewpoint, examples of favorable combination of inorganic compounds include Al₂O₃—ZrO₂, Al₂O₃—Gd₂O₃, Al₂O₃—Y₂O₃, Al₂O₃—Tb₄O₇, ZrO₂—Tb₄O₇, Al₂O₃—Gd₂O₃—Tb₄O₇, Al₂O₃—ZrO₂—Tb₄O₇, and Al₂O₃—Y₂O₃—Tb₄O₇.

Step (i): Step of Forming Powder Layer

There is no particular limitation regarding the method for feeding the powder. For example, feeding can be performed by using a powder feed device (not illustrated in the drawing) as disclosed in Japanese Patent Laid-Open No. 8-281807. In accordance with the thickness defined by the slice data, the position of the stage 151 is adjusted to the position at which the upper surface of the base 130 or the upper surface of the powder layer after being irradiated with an energy ray is lower than the upper edge of a container 153 by the amount corresponding to the thickness of one layer. Subsequently, the powder is fed onto the base 130 by using the powder feed device, and the powder is flattened by using the roller 152 so that a powder layer 102 can be formed (FIG. 4A, FIG. 4B). After the powder is fed, the powder layer 102 may be formed by leveling the surface of the powder with a layer-thickness-regulating device (for example, a blade). Preferably, a heat-resistant ceramic flat plate is used for the base 130.

Step (ii): Step of Applying Energy Ray to Powder Layer

Regarding step (ii) illustrated in FIGS. 4A to 4H, an example in which a predetermined region of the powder layer formed in step (i) is irradiated with an energy ray so that the section irradiated with the energy ray is melted and solidified will be described. Application of the energy ray is performed in accordance with slice data formed from the three-dimensional data of the structure. In this regard, a ceramic powder is used as a powder for shaping.

When the powder is irradiated with an energy ray, the powder absorbs the energy ray, the energy is converted to heat, and the powder is melted. After the application of the energy ray is completed, the molten powder is cooled by the atmosphere and the peripheral portion adjacent to the molten powder and is solidified so as to form a solidified portion 100 (FIG. 4C).

Regarding the energy ray to be used, a light source having an appropriate wavelength is selected in consideration of the absorption characteristics of the inorganic compound powder. To form the structure having a fine structure, it is preferable that a laser beam or an electron beam be adopted because the beam diameter can be narrowed and directivity is high. Examples of the energy ray suitable for the powder containing aluminum oxide as a primary component include laser beams such as YAG lasers and fiber lasers with a 1-μm waveband and CO₂ lasers with a 10-μm waveband. In the case in which the powder contains terbium oxide or praseodymium oxide, the YAG lasers with a 1-μm waveband are favorable.

To obtain a shaped material, step (i) and step (ii) above are repeated predetermined times. That is, a powder layer 102 is newly formed by step (i) on the solidified portion 100 obtained by step (ii), and the newly formed powder layer 102 is irradiated with an energy ray (FIG. 4D to FIG. 4F). The intensity of the energy ray is adjusted to the extent that the powder layer 102 on the solidified portion 100 is melted and the surface portion of the solidified portion 100 that is located under the powder layer 102 in the irradiated region and that is formed in advance is remelted. Consequently, the solidified portion 100 newly formed by application of the energy ray and the solidified portion 100 formed in advance can be integrated so that a shaped material having a shape in accordance with the three-dimensional data of the structure can be produced (FIG. 4G).

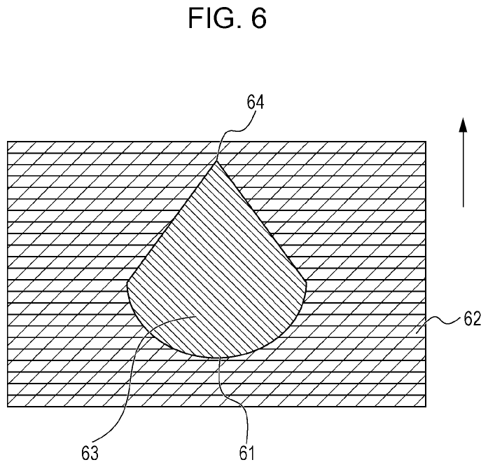

In the case in which the ceramic structure having a flow channel according to the present invention is produced by the powder bed system, it is preferable that shaping be performed in the direction indicated by the arrow in FIG. 6, that is, from the bottom portion 61 side of the elliptical portion toward the apex 64 of the triangular portion. Shaping being performed under such a condition enables the flow channel surrounded by a wall surface with high denseness and reduced unevenness to be produced.

For example, in the case in which the structure illustrated in FIGS. 1A and 1B is produced, it is preferable that step (i) and step (ii) be repetitively performed so as to form the powder layer on a surface perpendicular to the cross section of the micro flow channel. The energy ray is not applied to a portion 63 that serves as the flow channel, and the energy ray is applied to a portion 62 that serves as the structure. Since the powder in the portion not irradiated with the energy ray is neither melted nor solidified, the powder is left as is (unsolidified portion 63). After the ceramic structure is shaped by repeating step (i) and step (ii) predetermined times in accordance with the slice data of the structure, the powder in the unsolidified portion 63 is removed so as to form the flow channel.

Regarding shaping of the semielliptical portion, it is preferable that the area of the unsolidified portion 63 serving as the flow channel be gradually increased in accordance with the number of times of stacking the powder layer in the stacking direction. Regarding the flow channel, preferably, the portion including the major axis of the elliptical portion has the largest area in the stacking direction. The plane including the major axis of the semielliptical portion forms the boundary, and it is preferable that the area of the unsolidified portion 63 serving as the flow channel be gradually decreased in accordance with the number of times of stacking the powder layer.

Both angles (base angles) θ1 and θ2 of the triangular portion 22 in FIG. 2A are preferably 45 degrees or more. It is not desirable that the angles be less than 45 degrees because formation of the flow channel is unstable and the surface roughness of the inner wall of the flow channel increases due to a large decreasing rate of unsolidified portion on a layer basis. When viewed in the cross-sectional direction, if at least one of θ1 and θ2 is less than 45 degrees, the supplementary angle of the angle concerned is 135 degrees or more. Consequently, the inclination of the overhang of the solidified portion becomes excessively large, it becomes difficult to support the solidified portion by the unsolidified portion just under it, and there is a concern that the shape of the solidified portion may be deformed.

Meanwhile, if at least one of the two angles θ1 and θ2 is more than 90 degrees, since the angle other than θ1 and θ2 of the triangular portion 22 becomes excessively acute, the flow in the flow channel is hindered. Each of θ1 and θ2 is preferably 80 degrees or less and more preferably 60 degrees or less. Meanwhile, the corner radius of an angle θ3 of the triangular portion 22 is preferably 0.05 mm or more.

In the case of 2B, it is preferable that the triangular portion 22 be a triangle in which the angles θ4 and θ5 formed by the tangents of the elliptical portion 21 at two end points and the major axis are 45 degrees and in which a line segment g serves as one side. Two angles θ1 and θ2 of the triangular portion 22 are not limited to being angles equal to each other. However, both are preferably 45 degrees or more for the same reason as in FIG. 2A. In addition, each of θ1 and θ2 is preferably 90 degrees or less and more preferably 80 degrees or less as in FIG. 2A. Meanwhile, it is preferable that the corner of the angle θ3 of the triangular portion 22 have a shape with an obtuse end by being rounded or the like. In the case in which the corner of the angle θ3 is rounded, preferably, the corner is made into an arc having a radius of 0.05 mm or more. In the case in which the corner of the angle θ3 is cut, the width of the cut portion is preferably 0.3 mm or less.

After shaping, heating treatment may be performed for the purpose of increasing the density, enhancing the strength, or re-oxidizing the ceramic structure. At this time, coating or impregnation with an organic compound or an inorganic compound serving as a glaze is preferable since an increase in density or an enhancement of strength of the ceramic structure is expected compared with just heat treatment.

There is no particular limitation regarding a heating method, and a resistance heating system, an induction heating system, an infrared lamp system, a laser system, an electron beam system, or the like can be used in accordance with the purpose.

Regarding the ceramic structure obtained by repeating step (i) and step (ii), stress may be generated in the surface layer and the inside due to a rapid temperature change in the melting and solidification process during production, and microcracks may be formed. Therefore, it is preferable that steps (iii) and (iv) below be performed as treatment to compensate microcracks and to increase the density and enhance the mechanical strength of the ceramic structure.

(iii) Step of allowing the shaped material to absorb a metal-component-containing liquid
(iv) Step of heating the shaped material allowed to absorb the metal-component-containing liquid

Steps (iii) and (iv) will be described below in detail.

Step (iii): Step of Allowing Shaped Material to Absorb Metal-Component-Containing Liquid

A metal-component-containing liquid will be described. A favorable metal-component-containing liquid contains a raw material for forming a metal component that changes to a phase having a potential to establish a eutectic relationship with a phase constituting the shaped material due to heat treatment performed after being absorbed by the shaped material and contains an organic solvent and a stabilizer.

For example, in the case in which the shaped material is composed of aluminum oxide (Al₂O₃; melting temperature Tm: 2,070° C.), a liquid containing a zirconium compound can be used as the metal-component-containing liquid. In the case in which the raw material is absorbed by the shaped material mainly containing alumina, a material not containing a metal element other than zirconium is preferable. Regarding the raw material for forming the zirconium component, metal alkoxides and salt compounds such as chlorides and nitrates of zirconium can be used. Of these, using metal alkoxides is preferable since microcracks of an intermediate shaped material are allowed to homogeneously absorb a zirconium-component-containing liquid. Specific examples of zirconium alkoxide include zirconium tetraethoxide, zirconium tetra-n-propoxide, zirconium tetraisopropoxide, zirconium tetra-n-butoxide, and zirconium tetra-t-butoxide.

Initially, zirconium alkoxide is dissolved into an organic solvent so as to prepare a solution of zirconium alkoxide. The amount of the organic solvent added to zirconium alkoxide is preferably 5 or more and 30 or less on a molar ratio basis relative to the compound and more preferably 10 or more and 25 or less. In this regard, in the present invention, “the amount of X added on a molar ratio basis relative to Y” expresses that the amount of moles of X added is 5 times the amount of moles of Y. If the concentration of zirconium alkoxide in the solution is excessively low, the shaped material is unable to absorb sufficient amount of zirconium compound. On the other hand, if the concentration of zirconium alkoxide in the solution is excessively high, the zirconium compound in the solution coagulates, and the zirconium compound is unable to be homogeneously arranged in microcrack portions of an intermediate shaped material.

Regarding the organic solvent, alcohols, carboxylic acids, aliphatic or alicyclic hydrocarbons, aromatic hydrocarbons, esters, ketones, and ethers and solvent mixtures of at least two types of these are used. Preferable examples of alcohols include methanol, ethanol, 2-propanol, butanol, 2-methoxyethanol, 2-ethoxyethanol, 1-methoxy-2-propanol, 1-ethoxy-2-propanol, 1-propoxy-2-propanol, 4-methyl-2-pentanol, 2-ethylbutanol, 3-methoxy-3-methylbutanol, ethylene glycol, diethylene glycol, and glycerin. Preferable examples of aliphatic or alicyclic hydrocarbons include n-hexane, n-octane, cyclohexane, cyclopentane, and cyclooctane. Preferable examples of aromatic hydrocarbons include toluene, xylene, and ethylbenzene. Preferable examples of esters include ethyl formate, ethyl acetate, n-butyl acetate, ethylene glycol monomethyl ether acetate, ethylene glycol monoethyl ether acetate, and ethylene glycol monobutyl ether acetate. Preferable examples of ketones include acetone, methyl ethyl ketone, methyl isobutyl ketone, and cyclohexanone. Preferable examples of ethers include dimethoxyethane, tetrahydrofuran, dioxane, and diisopropyl ether. When a coating solution used in the present invention is prepared, of the above-described various solvents, it is preferable that alcohols be used from the viewpoint of the stability of the solution.

Next, the stabilizer will be described. Zirconium alkoxide has high reactivity with water and, therefore, is rapidly hydrolyzed by moisture in the air or addition of water so as to cause white turbidity of the solution or precipitation. To suppress white turbidity or precipitation from occurring, it is preferable that the stabilizer be added so as to stabilize the solution. Examples of the stabilizer include β-diketone compounds such as acetylacetone, 3-methyl-2,4-pentanedione, 3-ethyl-2,4-pentanedione, and trifluoroacetylacetone; β-ketoester compounds such as methyl acetoacetate, ethyl acetoacetate, butyl acetoacetate, allyl acetoacetate, benzyl acetoacetate, isopropyl acetoacetate, tert-butyl acetoacetate, isobutyl acetoacetate, ethyl 3-oxohexanoate, ethyl 2-methylacetoacetate, ethyl 2-fluoroacetoacetate, and 2-methoxyethyl acetoacetate; and alkanolamines such as monoethanolamine, diethanolamine, and triethanolamine. The amount of stabilizer added is preferably 0.1 or more and 3 or less on a molar ratio basis relative to zirconium alkoxide and more preferably 0.5 or more and 2 or less.

Regarding the preparation of the solution, the reaction may be performed at room temperature, or preparation may be performed by using reflux.

Meanwhile, in the case in which the shaped material is composed of two phases of Al₂O₃ and GdAlO₃, the melting temperature of the shaped material is determined in accordance with the composition ratio of the two phases. For example, when the two phases are in a eutectic composition, the melting temperature is about 1,720° C. Regarding the metal-component-containing liquid at this time, a zirconium-component-containing liquid in which a ZrO₂ phase is generated by heat treatment can be selected.

The powder melted by energy ray irradiation in step (i) is cooled by the environment and is solidified so as to form a solidified portion. In the case of ceramic, since a temperature difference between melting/solidification is large, microcracks may occur in the solidified portion. The microcracks remain in the shaped material.

The metal-component-containing liquid is distributed not only in the surface layer of the shaped material but also inside the shaped material along microcracks through step (iii). There is no particular limitation regarding the technique for impregnating the shaped material with the metal-component-containing liquid provided that a sufficient amount of metal component is allowed to be present in a sufficient region of microcracks of the shaped material. The shaped material may be dipped into the metal-component-containing liquid, the metal-component-containing liquid brought into a foggy state may be blown on the shaped material, or the metal-component-containing liquid may be applied by using a brush or the like. In this regard, some of these methods may be combined, or one technique may be repeated a plurality of times. In the case in which the metal-component-containing liquid is blown and in the case in which the metal-component-containing liquid is applied by coating, it is preferable that the amount of the metal-component-containing liquid blown or applied be 5% by volume or more and 20% by volume or less of the shaped material not impregnated with the metal-component-containing liquid. If the amount is less than 5% by volume, the amount of the metal component arranged in the microcrack portion of the shaped material is insufficient, and there is a concern that the microcrack portion is not limited to being melted.

Step (iv): Step of Heating the Shaped Material Allowed to Absorb the Metal-Component-Containing Liquid

In step (iv), the step of heating the shaped material allowed to absorb the metal-component-containing liquid is performed.

In the shaped material after being subjected to step (iii), there is the metal-component-containing liquid, that is, the metal component, distributed in microcracks in the shaped material surface layer and inside the shaped material. When such a shaped material is heat-treated, sintering or partial melting occurs in the microcrack portion in the portion in which there is the metal component, specifically in the microcrack portion in the shaped material surface layer and inside the shaped material. In the heating step, it is preferable that the highest temperature reached by the shaped material be higher than the eutectic temperature of the phase of the metal oxide formed from the metal-component-containing liquid and the phase constituting the shaped material and lower than the melting temperature of the phase constituting the shaped material.

When the microcrack portion reaches a temperature higher than the eutectic temperature of the phase of the metal oxide formed from the metal-component-containing liquid and the phase constituting the shaped material, the metal component distributed in the microcrack portion diffuses inside the crystal of the shaped material. Subsequently, the shaped material of the microcrack portion in which the metal component is present is melted. In a molten state, atoms diffuse in the direction in which the surface energy decreases, and thereafter the melted portion is recrystallized while the crystal contains the metal component by lowering the temperature so that microcracks are reduced. As a result, the bonding force between crystal structures of the shaped material is enhanced, and the abrasion resistance and the strength of the shaped material are improved to a great extent.

As described above, the zirconium-component-containing liquid is suitable for compensating a crack of the shaped material composed of aluminum oxide (Al₂O₃; melting temperature of 2,070° C.). A zirconia (ZrO₂; melting temperature of 2,715° C.) phase is formed from the zirconium-component-containing liquid by heat treatment. In this regard, the eutectic temperature of the Al₂O₃ and ZrO₂ is about 1,900° C. In this case, heating has to be performed so that the highest temperature reached by the microcrack portion during heat treatment is higher than 1,900° C. and lower than 2,070° C.

To improve the abrasion resistance, the metal component has to be sufficiently diffused inside the crystal of the shaped material. For this purpose, it is preferable that heating be performed at a temperature higher than the eutectic temperature of the phase of the metal oxide formed from the metal-component-containing liquid and the phase constituting the shaped material for a long time. The heating temperature being controlled so that the temperature of the microcrack portion falls within the above-described temperature range enables just the vicinity of the portion in which the metal component is present to be melted. Therefore, microcracks can be reduced without deforming the shape of the shaped material. Even if heating is performed for a long time, the shape of the shaped material is maintained provided that the heating temperature be controlled.

A sufficient amount of metal component being present in the microcrack portion has an effect of melting the shaped material in the vicinity of microcracks so as to reduce microcracks, as described above. For example, the vicinity of microcracks of the shaped material can be selectively melted by bringing the vicinity of microcracks close to the eutectic composition in which zirconium oxide is about 22% by mole relative to 78% by mole of the shaped material containing aluminum oxide as a primary component.

In this manner, the microcrack portion can be selectively melted, solidified, and recrystallized by impregnating the shaped material with the metal-component-containing liquid and thereafter performing heat treatment. Regarding the thus obtained shaped material, microcracks are reduced, and the abrasion resistance and the mechanical strength are improved to a great extent compared with those before treatment.

The example in which the structure is shaped by using the powder bed system has been described above. However, shaping can also be performed by using a cladding system.

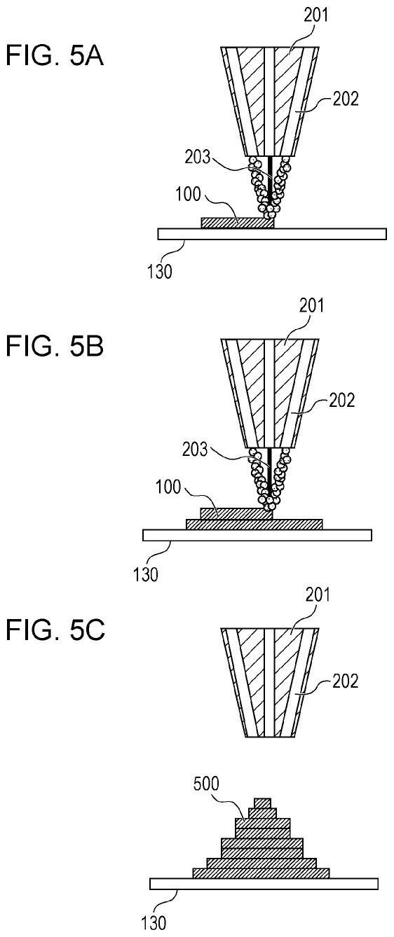

The cladding system will be described with reference to FIGS. 5A to 5C. The cladding system is a technique in which a powder is ejected from a plurality of powder feed holes 202 included in a cladding nozzle 201, a solidified portion 100 is additively formed on a predetermined place by applying an energy ray 203 to a region on which the powder is focused (FIG. 5A), and such a step is repetitively performed so as to obtain a shaped material 500 having a predetermined shape (FIG. 5B, FIG. 5C). Finally, as the situation demands, an unnecessary portion of the shaped material 500 is removed and the shaped material 500 is separated from the base 130.

According to the cladding system, unevenness is readily formed on the shaped material surface compared with the powder bed system. Consequently, from the viewpoint that the resistance in the flow channel is reduced by forming a micro flow channel having the inner wall with reduced unevenness, the powder bed system is favorable compared with the cladding system.

In this regard, the ceramic structure shaped by using the ceramic material has been described. However, the present invention is not limited to the ceramic material. In the same manner as the shaping by using the inorganic compound powder, a metal structure or a resin structure having a micro flow channel according to the present invention can be formed by using a metal power or a resin powder.

### EXAMPLE

The structure according to the present invention will be described below with reference to the examples. However, the present invention is not limited to the following examples.

### Example 1

A structure of 60 mm×57 mm×13 mm provided with 12 flow channels having a cross-sectional shape illustrated in FIG. 2A at a pitch of 2 mm in the inside was produced.

Initially, an α-Al₂O₃ powder, a Gd₂O₃ powder, and a Tb₂O_{3.5} powder (Tb₄O₇ powder) were prepared, and each powder was weighed so as to ensure Al₂O₃:Gd₂O₃:Tb₂O_{3.5}=77.4:20.8:1.8. The weighed powders were mixed in a dry ball mill for 30 minutes so as to obtain a powder mixture (material powder).

Subsequently, the shaped material of Example 1 was formed through essentially the same steps as the steps illustrated in FIGS. 4A to 4H above.

Regarding the formation of the shaped material, Prox DMP 200 produced by 3D SYSTEMS equipped with a 300-W Nd:YAG laser (beam diameter of 65 μm) was used.

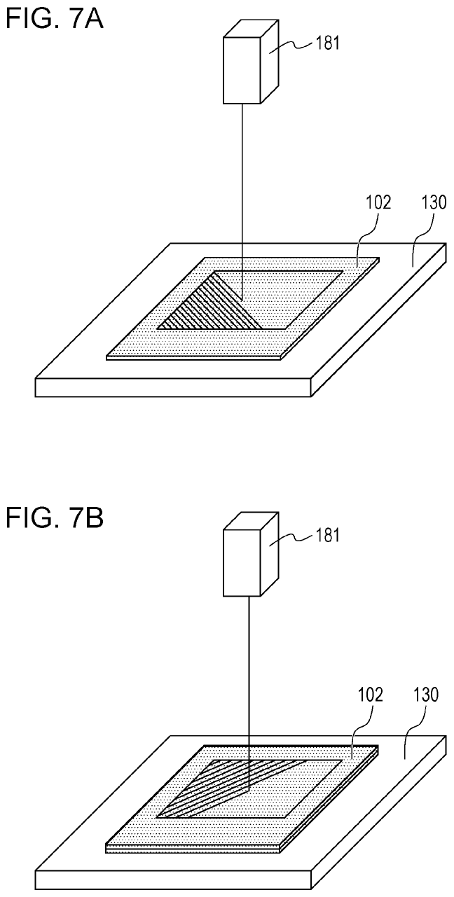

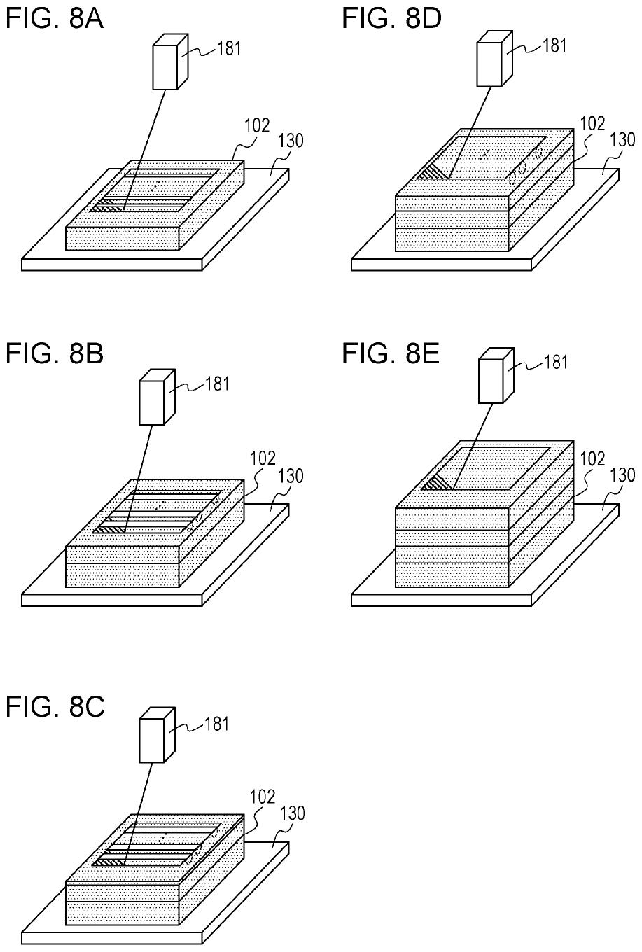

A powder layer serving as the first layer having a thickness of 20 μm was formed of the material powder on an alumina base by using a roller (step (i)). The powder layer was irradiated with a 30-W laser beam so as to melt and solidify the material powder in a rectangular region of 60 mm×57 mm. The drawing rate was set to be 100 mm/s to 140 mm/s, and the drawing pitch was set to be 100 μm. As illustrated in FIG. 7A, the drawing line was diagonally set at an angle of 45 degrees with respect to the rectangle (step (ii)). A powder layer having a thickness of 20 μm was newly formed by using a roller so as to cover the melted and solidified portion (step (i)). As illustrated in FIG. 7B, the powder layer immediately above the rectangular region was irradiated with laser in the way orthogonal to the drawing line of the first layer, so as to melt and solidify the material powder in a region of 60 mm×57 mm (step (ii)). Such steps were repeated so as to form an intermediate shaped material in the shape of a rectangle of 60 mm×57 mm with a height of 5.5 mm. A powder layer having a thickness of 20 μm was formed on the intermediate shaped material, and the vicinity of the bottom portion of the substantially elliptical portion of the flow channel was formed by scanning laser so that the length of the unsolidified portion was set to be 398 μm in the cross-sectional direction and to be 60 mm in the direction vertical to the cross section, as illustrated in FIG. 8A. In this regard, adjustment was performed to obtain the shaped material having predetermined dimensions by measuring the width melted and solidified by laser irradiation (solidification line width) in advance and performing correction. The number of times of stacking at this time was assumed to be n=1. Thereafter, laser scanning and stacking were repeated so that the length of the unsolidified portion became 2×(20 μm×n×(2×1 mm−20 μm×n))^{0.5}, and shaping was performed until the height of the elliptical portion of the flow channel reached 1 mm. The number of flow channels formed was 12 with a pitch of 2 mm. Subsequently, as illustrated in FIG. 8C, the triangular portion of the flow channel was formed by scanning laser so that the width of the unsolidified portion was set to be 1,960 μm in the cross-sectional direction and the length of the unsolidified portion was set to be 60 mm in the direction vertical to the cross section. The number of times of stacking at this time was assumed to be m=1. Laser scanning and stacking were repeated so that the width of the unsolidified portion in the cross-sectional direction became 2×(1 mm−20 μm×m), and shaping was performed until the height of the triangular portion of the flow channel reached 1 mm, as illustrated in FIG. 8D. Thereafter, as illustrated in FIG. 8E, a solidified portion having a height of 5.5 mm was further formed so as to obtain a shaped material including the unsolidified portion in the inside. The above-described intermediate shaped material was cut off the alumina base, and unsolidified powder in the shaped material was removed by washing so as to obtain a shaped material having the flow channel. The surface of the shaped material was observed by using an optical microscope, and, as a result, the unevenness of the shaped material surface was 20 μm or less.

Subsequently, the resulting shaped material was allowed to absorb a zirconium-component-containing liquid and was heated so as to be subjected to treatment to reduce microcracks.

The zirconium-component-containing liquid was produced as described below. A solution in which 85% by weight of zirconium (IV) butoxide (hereafter referred to as Zr(O-n-Bu)₄) was dissolved in 1-butanol was prepared. The solution of Zr(O-n-Bu)₄ was dissolved into 2-propanol (IPA) and ethyl acetoacetate (EAcAc) serving as a stabilizer was added. The molar ratio of each component was set to be Zr(O-n-Bu)₄:IPA:EAcAc=1:15:2. Thereafter, agitation was performed at room temperature for about 3 hours so as to produce the zirconium-component-containing liquid.

The shaped material of Example 1 was dipped into the zirconium-component-containing liquid, and deaeration under reduced pressure was performed for 1 minute so that the liquid was allowed to permeate inside. Thereafter, natural drying was performed for 1 hour (step (iii)).

The shaped material impregnated with the zirconium-component-containing liquid was placed into an electric furnace and was heated. The temperature was increased to 1,670° C. over 4 hours in the air atmosphere, maintained at 1,670° C. for 30 minutes, and cooled to 200° C. or lower over 6 hours (step (iv)).

By the above-described procedure, a ceramic structure in which a flow channel having a cross-sectional shape composed of an elliptical portion and a triangular portion was provided was obtained.

### Examples 2 to 34

The type of the raw material powder and the cross-sectional shape of the flow channel were changed so as to produce a plurality of types of ceramic structures.

The ceramic structure of each of Example 2 to Example 23 was designed to have a shape illustrated in FIG. 2A in which one side of the triangular portion of the cross section of the flow channel was the major diameter of the elliptical portion in the same manner as in Example 1 and was formed where the composition of the used raw material powder was changed.

The design dimensions of the elliptical portion and the triangular portion and the raw material powder mixing ratio of each of Example 1 to Example 23 are described in Table 1. The structure was shaped in the same manner as in Example 1. However, regarding the example in which “none” is entered in the column “Step (iii) and step (iv)”, the treatment to reduce cracks was not performed after shaping.

The ceramic structure of each of Example 24 to Example 34 was designed to have a shape illustrated in FIG. 2B in which the elliptical portion 21 of the cross section of the flow channel was larger than the semielliptical portion. The angles θ4 and θ5 formed by the two tangents of the elliptical portion 21 and the major axis were set to be 45 degrees, and one side of the triangular portion 22 was set to be the line segment g that bonded two contact points between the two tangents and the elliptical portion 21. The design dimensions of the elliptical portion and the triangular portion and the raw material powder mixing ratio of each of Example 24 to Example 34 are described in Table 2.

TABLE 1

| | Flow channel shape | | | | | | | Step | | | | | | | |
|---|---|---|---|---|---|---|---|---|---|---|---|---|---|---|---|
| | | | | | | Cross- | | (iv) | Raw material powder | | | | | | |
| | Semiellipse | | | Triangle | | sectional | | and | Al₂O₃ | Gd₂O₃ | Tb₂O_{3.5} | ZrO₂ | SiO₂ | | |
| | a | b | | θ1 | θ2 | area | Area | step | (molar | (molar | (molar | (molar | (molar | | (3π + |
| | [mm] | [mm] | e | [degree] | [degree] | [mm²] | ratio R | (v) | ratio) | ratio) | ratio) | ratio) | ratio) | πa²/8 | 6)a²/16 |
| Example 1 | 2 | 2 | 0.00 | 45 | 45 | 2.57 | 0.64 | yes | 77.4 | 20.8 | 1.8 | 0 | 0 | 1.57 | 3.14 |
| Example 2 | 0.5 | 0.5 | 0.00 | 45 | 45 | 0.16 | 0.64 | yes | 77.4 | 20.8 | 1.8 | 0 | 0 | 0.10 | 0.20 |
| Example 3 | 3.5 | 3.5 | 0.00 | 45 | 45 | 7.87 | 0.64 | yes | 77.4 | 20.8 | 1.8 | 0 | 0 | 4.81 | 9.62 |
| Example 4 | 0.8 | 0.8 | 0.00 | 45 | 45 | 0.41 | 0.64 | yes | 77.4 | 20.8 | 1.8 | 0 | 0 | 0.25 | 0.50 |
| Example 5 | 3.2 | 3.2 | 0.00 | 45 | 45 | 6.58 | 0.64 | yes | 77.4 | 20.8 | 1.8 | 0 | 0 | 4.02 | 8.04 |
| Example 6 | 2 | 2 | 0.00 | 50 | 55 | 2.87 | 0.83 | yes | 77.4 | 20.8 | 1.8 | 0 | 0 | 1.57 | 3.14 |
| Example 7 | 2 | 0.9 | 0.89 | 55 | 60 | 2.27 | 2.21 | yes | 77.4 | 20.8 | 1.8 | 0 | 0 | 1.57 | 3.14 |
| Example 8 | 2 | 0.7 | 0.94 | 80 | 59 | 3.12 | 4.68 | yes | 77.4 | 20.8 | 1.8 | 0 | 0 | 1.57 | 3.14 |
| Example 9 | 2 | 1 | 0.87 | 90 | 45 | 2.79 | 2.55 | yes | 77.4 | 20.8 | 1.8 | 0 | 0 | 1.57 | 3.14 |
| Example 10 | 2 | 0.8 | 0.92 | 45 | 45 | 1.63 | 1.59 | yes | 77.4 | 20.8 | 1.8 | 0 | 0 | 1.57 | 3.14 |
| Example 11 | 2 | 0.87 | 0.90 | 45 | 45 | 1.68 | 1.46 | yes | 77.4 | 20.8 | 1.8 | 0 | 0 | 1.57 | 3.14 |
| Example 12 | 2 | 1 | 0.87 | 45 | 45 | 1.79 | 1.27 | yes | 77.4 | 20.8 | 1.8 | 0 | 0 | 1.57 | 3.14 |
| Example 13 | 1 | 0.5 | 0.87 | 95 | 45 | 0.74 | 2.79 | none | 77.4 | 20.8 | 1.8 | 0 | 0 | 0.39 | 0.79 |
| Example 14 | 2 | 2 | 0.00 | 45 | 45 | 2.57 | 0.64 | yes | 48.2 | 48.2 | 3.5 | 0 | 0.14 | 1.57 | 3.14 |
| Example 15 | 0.5 | 0.5 | 0.00 | 45 | 45 | 0.16 | 0.64 | yes | 48.2 | 48.2 | 3.5 | 0 | 0.14 | 0.10 | 0.20 |
| Example 16 | 3.5 | 3.5 | 0.00 | 45 | 45 | 7.87 | 0.64 | yes | 48.2 | 48.2 | 3.5 | 0 | 0.14 | 4.81 | 9.62 |
| Example 17 | 0.8 | 0.8 | 0.00 | 45 | 45 | 0.41 | 0.64 | yes | 48.2 | 48.2 | 3.5 | 0 | 0.14 | 0.25 | 0.50 |
| Example 18 | 3.2 | 3.2 | 0.00 | 45 | 45 | 6.58 | 0.64 | yes | 48.2 | 48.2 | 3.5 | 0 | 0.14 | 4.02 | 8.04 |
| Example 19 | 2 | 2 | 0.00 | 45 | 45 | 2.57 | 0.64 | yes | 47.4 | 0 | 5.1 | 47.4 | 0.1 | 1.57 | 3.14 |
| Example 20 | 0.5 | 0.5 | 0.00 | 45 | 45 | 0.16 | 0.64 | none | 47.4 | 0 | 5.1 | 47.4 | 0.1 | 0.10 | 0.20 |
| Example 21 | 3.5 | 3.5 | 0.00 | 45 | 45 | 7.87 | 0.64 | none | 47.4 | 0 | 5.1 | 47.4 | 0.1 | 4.81 | 9.62 |
| Example 22 | 0.8 | 0.8 | 0.00 | 45 | 45 | 0.41 | 0.64 | yes | 47.4 | 0 | 5.1 | 47.4 | 0.1 | 0.25 | 0.50 |
| Example 23 | 3.2 | 3.2 | 0.00 | 45 | 45 | 6.58 | 0.64 | yes | 47.4 | 0 | 5.1 | 47.4 | 0.1 | 4.02 | 8.04 |
| Comparative | 5 | 1.5 | 0.95 | 20 | 20 | 5.22 | 0.77 | none | 77.4 | 20.8 | 1.8 | 0 | 0 | 9.82 | 19.63 |
| example 1 | | | | | | | | | | | | | | | |

TABLE 2

| | Flow channel shape | | | | | | | | Raw material powder | | | | | | |
|---|---|---|---|---|---|---|---|---|---|---|---|---|---|---|---|
| | Semiellipse | | | Triangle | | Cross- | | Step (iv) | Al₂O₃ | Gd₂O₃ | Tb₂O_{3.5} | ZrO₂ | SiO₂ | | |
| | a | b | | θ1 | θ2 | sectional | Area | and step | (molar | (molar | (molar | (molar | (molar | | (3π + |
| | [mm] | [mm] | e | [degree] | [degree] | area [mm²] | ratio R | (v) | ratio) | ratio) | ratio) | ratio) | ratio) | πa²/8 | 6)a²/16 |
| Example 24 | 2 | 2 | 0 | 45 | 45 | 3.36 | 0.18 | yes | 77.4 | 20.8 | 1.8 | 0 | 0 | 1.57 | 3.86 |
| Example 25 | 2 | 2 | 0 | 90 | 45 | 3.86 | 0.35 | yes | 77.4 | 20.8 | 1.8 | 0 | 0 | 1.57 | 3.86 |
| Example 26 | 2 | 2 | 0 | 60 | 60 | 3.72 | 0.30 | yes | 77.4 | 20.8 | 1.8 | 0 | 0 | 1.57 | 3.86 |
| Example 27 | 0.5 | 0.5 | 0 | 45 | 45 | 0.21 | 0.18 | yes | 77.4 | 20.8 | 1.8 | 0 | 0 | 0.10 | 0.24 |
| Example 28 | 0.5 | 0.5 | 0 | 60 | 60 | 0.23 | 0.30 | yes | 77.4 | 20.8 | 1.8 | 0 | 0 | 0.10 | 0.24 |
| Example 29 | 3.5 | 3.5 | 0 | 45 | 45 | 10.28 | 0.18 | yes | 77.4 | 20.8 | 1.8 | 0 | 0 | 4.81 | 11.81 |
| Example 30 | 3.5 | 3.5 | 0 | 60 | 60 | 11.40 | 0.30 | yes | 77.4 | 20.8 | 1.8 | 0 | 0 | 4.81 | 11.81 |
| Example 31 | 0.8 | 0.8 | 0 | 45 | 45 | 0.54 | 0.18 | yes | 77.4 | 20.8 | 1.8 | 0 | 0 | 0.25 | 0.62 |
| Example 32 | 0.8 | 0.8 | 0 | 60 | 60 | 0.60 | 0.30 | yes | 77.4 | 20.8 | 1.8 | 0 | 0 | 0.25 | 0.62 |
| Example 33 | 3.2 | 3.2 | 0 | 45 | 45 | 8.59 | 0.18 | yes | 77.4 | 20.8 | 1.8 | 0 | 0 | 4.02 | 9.87 |
| Example 34 | 3.2 | 3.2 | 0 | 60 | 60 | 9.53 | 0.30 | yes | 77.4 | 20.8 | 1.8 | 0 | 0 | 4.02 | 9.87 |

### Comparative Example 1

A structure having a shape in which one side of the triangular portion of the cross section of the flow channel was set to be the major diameter of the elliptical portion was produced in the same manner as in Example 1. The design dimensions of the structure of Comparative example 1 are described in Table 1. In Comparative example 1, each of θ1 and θ2 of the triangular portion was 20 degrees and, therefore, was less than 45 degrees.

### Example 35

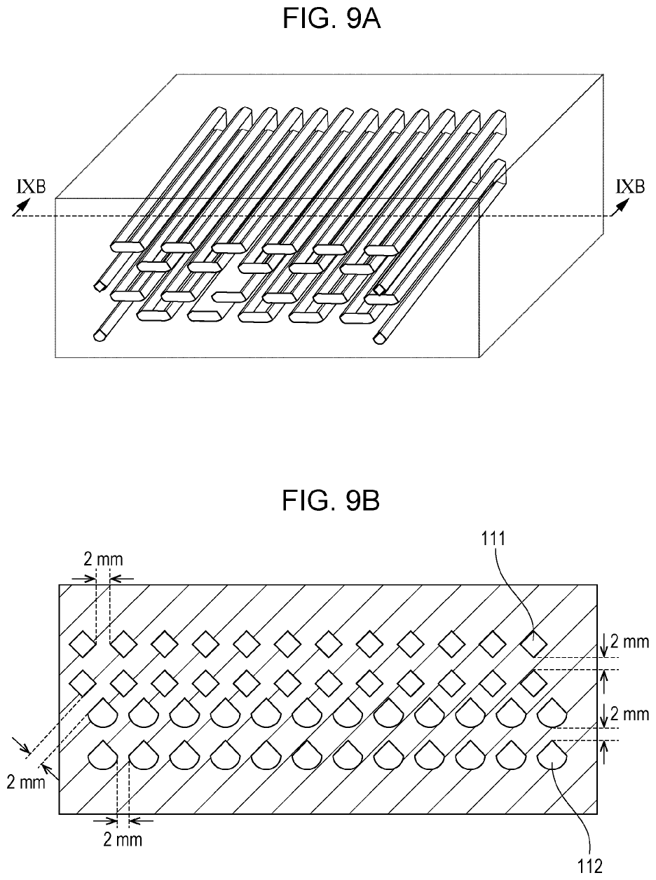

As illustrated in FIG. 9A, a structure having a micro flow channel including turn portions at end portions of the structure was formed through the same steps as in Example 1. FIG. 9B is a sectional view illustrating the cross section cut along line IXB-IXB. As illustrated in FIG. 9B, a high-temperature liquid flow channel 111 and a low-temperature liquid flow channel 112 were formed. The high-temperature liquid flow channel 111 was a flow channel having a square cross-sectional shape with a diagonal of 2 mm. Regarding the cross section of the low-temperature liquid flow channel 112, the elliptical portion 21 was set to be a semicircle having a diameter of 2 mm, and the triangular portion was set to be an isosceles triangle in which one side was the diameter of the semicircle. The flow channel length of each flow channel was designed to be 1 m.

### Comparative Example 2

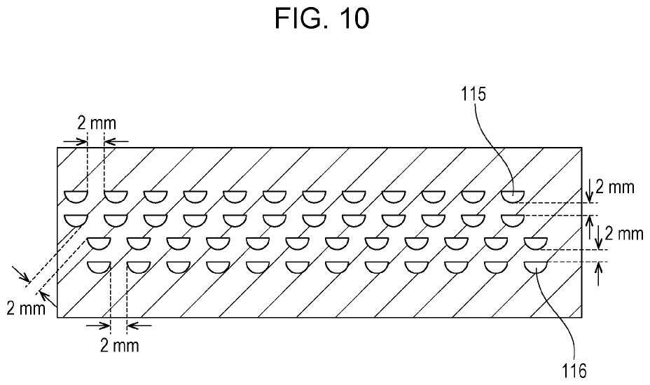

To compare with Example 35, a structure having a micro flow channel that had a cross section as illustrated in FIG. 10 was formed. In the micro flow channel illustrated in FIG. 10, each of a high-temperature liquid flow channel 115 and a low-temperature liquid flow channel 116 had the shape of a semicircle having a diameter of 2 mm. The minimum distance between the respective flow channels was designed to be 2 mm equal to FIG. 9B in Example 1, and each flow channel length was designed to be 1 m.

### Examples 36 to 69

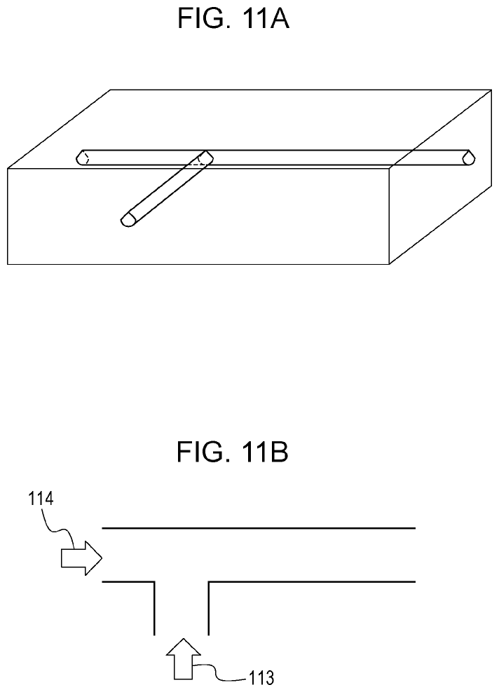

T-shaped micro flow channels as illustrated in FIGS. 11A and 11B of Example 36 to Example 69 having the same cross-sectional shapes of the flow channels as those of Example 1 to Example 34, respectively, were shaped through the same steps as in Example 1. FIG. 11A is an overall view of the resulting structure, and FIG. 11B is a top view of the flow channel formed in the structure.

### Comparative Example 3

To compare with Example 36, the same structure as the structure in Example 36 was produced in Comparative example 3 except that the cross-sectional shape of the flow channel was changed to the same shape as in Comparative example 1.

Evaluation of Shape

The structure of each of Examples 1 to 34 and Comparative example 1 was cut and polished, and the shape of the cross section of the flow channel was observed by using an optical microscope. The cross-sectional area of the flow channel and the major diameter of the semielliptical portion at that time were measured. The resulting cross-sectional area and the major diameter are described in Table 3. Further, the edge of the cross section of the micro flow channel measured by using an optical microscope was extracted by image processing, and fitting was performed by using the designed external shape and a least square method. The absolute value of the largest error at that time was determined.

Regarding Comparative example 1, the largest error was more than 0.5 mm and, therefore, was not desirable because the inner wall of the flow channel had large unevenness so as to hinder the flow.

TABLE 3

| | | | | Largest |
|---|---|---|---|---|
| | Major axis | Cross- | Largest | error/major |
| | diameter | sectional | error | axis diameter |
| | [mm] | area [mm²] | [mm] | [%] |
| Example 1 | 2.04 | 2.51 | 0.12 | 5.9 |
| Example 2 | 0.53 | 0.17 | 0.08 | 15.1 |
| Example 3 | 3.48 | 7.91 | 0.41 | 11.8 |
| Example 4 | 0.81 | 0.40 | 0.05 | 6.2 |
| Example 5 | 3.20 | 6.59 | 0.22 | 6.9 |
| Example 6 | 2.03 | 2.86 | 0.11 | 5.4 |
| Example 7 | 1.98 | 2.21 | 0.13 | 6.6 |
| Example 8 | 2.02 | 3.14 | 0.12 | 5.9 |
| Example 9 | 2.01 | 2.77 | 0.13 | 6.5 |
| Example 10 | 1.99 | 1.66 | 0.10 | 5.0 |
| Example 11 | 2.01 | 1.68 | 0.11 | 5.5 |
| Example 12 | 2.04 | 1.76 | 0.12 | 5.9 |
| Example 13 | 0.99 | 0.73 | 0.08 | 8.1 |
| Example 14 | 1.98 | 2.55 | 0.12 | 6.1 |
| Example 15 | 0.51 | 0.16 | 0.08 | 15.7 |
| Example 16 | 3.50 | 7.86 | 0.42 | 12.0 |
| Example 17 | 0.79 | 0.43 | 0.07 | 8.9 |
| Example 18 | 3.18 | 6.55 | 0.23 | 7.2 |
| Example 19 | 2.02 | 2.58 | 0.18 | 8.9 |
| Example 20 | 0.52 | 0.16 | 0.08 | 15.4 |
| Example 21 | 3.49 | 7.85 | 0.40 | 11.5 |
| Example 22 | 0.81 | 0.44 | 0.05 | 6.2 |
| Example 23 | 3.18 | 6.59 | 0.23 | 7.2 |
| Example 24 | 2.03 | 3.38 | 0.11 | 5.4 |
| Example 25 | 2.01 | 3.84 | 0.12 | 6.0 |
| Example 26 | 2.00 | 3.72 | 0.13 | 6.5 |
| Example 27 | 0.52 | 0.20 | 0.08 | 15.4 |
| Example 28 | 0.52 | 0.23 | 0.08 | 15.4 |
| Example 29 | 3.49 | 10.26 | 0.43 | 12.3 |
| Example 30 | 3.48 | 11.39 | 0.42 | 12.1 |
| Example 31 | 0.82 | 0.52 | 0.06 | 7.3 |
| Example 32 | 0.81 | 0.58 | 0.05 | 6.2 |
| Example 33 | 3.18 | 8.58 | 0.22 | 6.9 |
| Example 34 | 3.20 | 9.52 | 0.23 | 7.2 |
| Comparative | 5.02 | 3.77 | 0.81 | 16.1 |
| example 1 | | | | |

Evaluation of Composition

Part of the shaped material of each of Examples 1 to 34 and Comparative example 1 was dissolved into an acid, and the composition was analyzed by using an ICP emission spectroscopic analysis method. As a result, it was identified that the composition was as described in Table 1 or Table 2.

Evaluation of Performance

Water at 80° C. was circulated through the high-temperature liquid flow channel 111 of Example 35 illustrated in FIGS. 9A and 9B, water at 25° C. was passed through the low-temperature liquid flow channel 112, and the outlet temperature was measured. As a result, 75° C. was the highest, and an increase in temperature of the water due to heat exchange was ascertained.

Water at 80° C. was circulated through the high-temperature liquid flow channel of Comparative example 2 illustrated in FIG. 10, water at 25° C. was passed through the low-temperature liquid flow channel, and the outlet temperature was measured. As a result, the highest was about 60° C., and an increase in temperature of the water due to heat exchange was small compared with Example 35.

An organic solvent 113 and water 114 were fed from the respective feed port of the structure that had a T-shaped flow channel and that was produced in each of Example 36 to Example 69 and were merged. As a result, it was ascertained that a uniform-size emulsion resulted. Since the flow channel of each of Example 36 to Example 69 according to the present invention had excellent rectification performance, a homogeneous dispersion liquid was obtained. Consequently, a homogeneous chemical reaction can be realized by using the flow channel according to the present invention. On the other hand, when the organic solvent and the water were similarly passed through the flow channel of Comparative example 3 and were merged, a nonuniform-size emulsion resulted. In Comparative example 3, a turbulent flow occurred, and a homogeneous dispersion liquid was not obtained.

According to comparisons between Example 3 and Comparative example 1, the cross-sectional area in Comparative example 1 was small in spite of the major diameter a being large compared with Example 3. As a result, the quantity of flow at an equal flow speed was small.

Helium gas was passed through the flow channel of each of Example 1 to Example 35 so as to perform a leakage test. As a result, leakage was not recognized and it was ascertained that favorable hermeticity was exhibited.

The structure of each of Example 1 to Example 35 was dipped into sodium hydroxide and hydrochloric acid. Deformation of the structure was not observed. Meanwhile, the solvent after dipping was subjected to composition analysis by using an ICP emission spectroscopic analysis method. The component of the structure of each example was several ppm or less, and it was ascertained that the structure of each example had high corrosion resistance.

A fluid was passed through the flow channel of each of Example 1 to Example 34, and the amount of bubbles discharged from each flow channel until the quantity of the flow became constant was measured with a camera. A two-dimensional image of a bubble (projected image of a bubble) that passes through a glass tube connected to the outlet of the flow channel was acquired, the equivalent circle diameter and the volume of a sphere having the above-described diameter were calculated from the area of the projected image, and the result was assumed to be the volume of the bubble. Imaging was performed for 3 minutes, and the volume of discharged bubbles was roughly estimated. As a result, regarding Examples 1 to 7 and Examples 9 to 34, in which R was 3 or less, the amount of bubbles discharged was 20% larger than Example 8 in which R was more than 3. Regarding Examples 1 to 7 and Examples 9 to 34, in which R was 3 or less, a larger amount of bubbles in the flow channel was discharged to the outside than Example 8 in which R was more than 3, and further excellent rectification performance could be obtained.

Subsequently, the fluid was passed through the flow channel of each of Example 1 to Example 34 and Comparative example 1, and after the quantity of the flow became constant, the same measurement as above was performed so as to calculate the amount of bubbles discharged from each flow channel. As a result, regarding Examples 1 to 34, in which a triangular portion was included in the flow channel cross section, the amount of bubbles discharged from the flow channel was 20% less than Comparative example 1 in which a triangular portion was not included. This indicates that regarding Examples 1 to 34, movement of remaining gas in the flow channel after the quantity of flow became constant was suppressed. The reason for this is conjectured that remaining gas was held in the vicinity of the apex portion of the triangular shape. Consequently, excellent rectification performance could be obtained compared with Comparative example 1.

The example in which the ceramic powder was used, and the powder layer was irradiated with an energy ray so as to selectively harden a predetermined region in accordance with slice data has been described above. However, the method for hardening the powder layer is not limited to this example.

Examples include a method in which a binder is ejected to a powder layer in accordance with the slice data by using an ink jet method or the like and performing hardening and a method in which a bonding initiator is ejected to a powder layer that is a mixture of an inorganic material and a resin material serving as a binder. Alternatively, a method in which heat for selectively melting a resin material is applied to a powder layer that is a mixture of an inorganic material and the resin material serving as a binder by a laser or the like so as to selectively harden a predetermined region in accordance with the slice data may be adopted.

Meanwhile, the structure having a flow channel according to the present invention can also be produced by stacking a highly viscous fluid mixture in which a powder and a binder are mixed in accordance with the slice data. In this case, there is no particular limitation regarding the type of the binder. For example, thermoplastic binders such as vinyl acetate and wax are favorable. In the case in which the thermoplastic binder is used, a structure is produced by, for example, the following procedure.

Initially, a mixture in which powders such as ceramic and a metal serving as raw materials and a thermoplastic binder are heat-kneaded is placed into an injection molding machine or an extruder. Subsequently, the mixture is heat-kneaded in the cylinder of the molding machine so that the thermoplastic binder is melted and becomes a fluid mixture having fluidity. Thereafter, the fluid mixture is extruded from the molding machine and is stacked so that a formed body having a predetermined internal flow channel shape is completed.

The thermoplastic binder is decomposed and vaporized and the raw material powder is sintered by the formed body being heated in a vacuum or a reducing atmosphere such as hydrogen in the case in which the formed body is non-oxide ceramic and a metal or being heated in the air in the case in which the formed body is oxide ceramic so that the formed body having a predetermined internal flow channel shape is completed.

The powder used for shaping is not limited to the ceramic powder and may be appropriately selected from metal powders and resin powders and powder mixtures of these in accordance with the shaping method and the characteristics of the structure to be produced and may be used.

In this regard, the micro flow channel has been described. However, there is no particular limitation regarding the size of the flow channel, and the present invention can be applied to various sizes of flow channels which are used for various applications.

When the flow channel according to the present invention is used, it is preferable to construct a system in which a fluid feed device for feeding a fluid such as a liquid or gas to the flow channel is connected to the feed port of the flow channel, and the fluid is fed into the flow channel by a pressure mechanism included in the fluid feed device. Regarding the pressure mechanism, a pressure pump or a system which provides momentum to the fluid by exploiting potential energy may be adopted. Consequently, the fluid does not remain in the flow channel, and the fluid can be taken off the discharge port of the flow channel. In the case in which there are a plurality of feed ports, a fluid feed device may be connected to each feed port. In the case in which the same fluid is fed, the plurality of feed ports may be connected to one fluid feed mechanism. Meanwhile, in the case in which a fluid is not readily discharged from the flow channel due to a narrow flow channel, a long flow channel, or the like, discharge of the fluid may be facilitated by providing a suction mechanism to the discharge port.

According to the present invention, a structure having a micro flow channel that is excellent in rectification performance and durability can be provided.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

1. A structure comprising:
a flow channel in the inside,
wherein the cross section of the flow channel has a shape in which a region surrounded by a substantially elliptical curve and a line segment is connected to a triangular region with the base being the line segment,
the region surrounded by a substantially elliptical curve and a line segment is semielliptical or more, and
the base angle of the triangular region is 45 degrees or more.

2. The structure according to claim 1,
wherein the structure has a first flow channel and a second flow channel,
the first flow channel has a cross-sectional shape in which a region surrounded by a substantially elliptical curve and a line segment is connected to a triangular region with the base being the line segment, and
regarding the region surrounded by a line segment and a substantially elliptical curve, the substantially elliptical curve is semielliptical or more, and the base angle of the triangular region is 45 degrees or more.

3. The structure according to claim 2, wherein the cross-sectional shape of the second flow channel in the structure is a quadrilateral having a side parallel to the side constituting the triangular region of the first flow channel.

4. The structure according to claim 1, wherein the area S of the cross section satisfies the relationship represented by πa²/8<S≤(3π+6)a²/16 where a denotes the major diameter of the substantial ellipse.

5. The structure according to claim 4, wherein the major diameter a satisfies 0.5 mm≤a≤3.5 mm and the eccentricity e of the substantial ellipse satisfies 0≤e≤0.95.

6. The structure according to claim 1, wherein the region surrounded by a substantially elliptical curve and a line segment is a semiellipse.

7. The structure according to claim 1, wherein an angle formed by the tangent at each of two end points of the line segment and the major axis of the substantial ellipse is 45 degrees.

8. The structure according to claim 1, wherein the ratio R of the area of the triangular region with the base being the line segment to the area of the region surrounded by a substantially elliptical curve and a line segment satisfies the relationship represented by 0<R≤3.

9. The structure according to claim 1, wherein the flow channel length of the flow channel is 10 times or more the major diameter of the substantial ellipse.

10. The structure according to claim 1, wherein at least the region surrounding the flow channel of the structure is composed of a ceramic material.

11. The structure according to claim 10, wherein at least the region surrounding the flow channel of the structure contains zirconium oxide.

12. The structure according to claim 10, wherein at least the region surrounding the flow channel of the structure contains aluminum oxide or zirconium oxide as a primary component.

13. A reaction system wherein a fluid feed device is connected to one end portion of the flow channel of the structure according claim 1, and a suction mechanism is connected to the other end portion of the flow channel.

14. A method for manufacturing the structure according to claim 10 comprising the steps of:
(i) forming a powder layer containing an inorganic compound powder; and
(ii) selectively hardening a predetermined region of the powder layer in accordance with shaping data,
wherein the structure is produced by repeating the steps (i) and (ii).

15. The method for manufacturing the structure according to claim 14, wherein the powder is hardened by applying an energy ray in accordance with the shaping data in the step (ii).

16. The method for manufacturing the structure according to claim 14 further comprising the steps of:
(iii) impregnating a shaped material with a metal-component-containing liquid; and
(iv) heating the shaped material impregnated with the metal-component-containing liquid with respect to the shaped material obtained by repeating the steps (i) and (ii).

17. A method for manufacturing the structure according to claim 10 further comprising the steps of
(v) forming a mixture layer composed of the inorganic compound powder and the resin; and
(vi) selectively hardening a predetermined region of the mixture layer in accordance with shaping data,
wherein the structure is produced by repeating the steps (v) and (vi).
